(19) United States
(12) Patent Application Publication
(10) Pub. No.: US 2019/0079278 A1
(43) Pub. Date: Mar. 14, 2019

(54) LENS MODULE FOR ENDOSCOPE AND ENDOSCOPE USING THE SAME

(71) Applicant: MPNICS CO., LTD., Gwangju (KR)

(72) Inventors: Seung Keun OH, Gwangju (KR); Sang Do KANG, Gwangju (KR)

(73) Assignee: MPNICS CO., LTD., Gwangju (KR)

(21) Appl. No.: 15/824,586

(22) Filed: Nov. 28, 2017

(30) Foreign Application Priority Data
Sep. 14, 2017 (KR) 10-2017-0117566

(51) Int. Cl. G02B 23/24; G02B 7/02

(52) U.S. Cl. CPC G02B 23/243; G02B 7/021

(57) ABSTRACT

Disclosed are a lens module for an endoscope and an endoscope using the same. The lens module includes: a case that is shaped as a tube and has a holding space formed therein, and a plurality of lenses arranged inside the case; wherein the plurality of lenses include a first lens and a second lens that are positioned adjacently and are separated by a particular distance in-between; and the first lens comprises a first forward-direction protrusion protruding towards the second lens from an edge region of a radial direction, with the first forward-direction protrusion formed as an integrated body with the first lens to control the distance between the first lens and the second lens. Thus, the lens module can be fabricated by sequentially inserting the lenses without having to insert a separate spacer or form a step or curb in the inner wall of the case.

### CROSS REFERENCE TO RELATED APPLICATION

The present application claims priority to Korean Patent Application No. 10-2017-0117566, filed Sep. 14, 2017, the entire contents of which is incorporated herein for all purposes by this reference.

### BACKGROUND OF THE INVENTION

### Field of the Invention

The present invention relates generally to a lens module for an endoscope and an endoscope using the same. More particularly, the present invention relates to a lens module for an endoscope and an endoscope using the lens module with which the distance between the lenses can be controlled by way of the structure of the lens itself without having to use a separate spacer.

### Description of the Related Art

Generally, a medical endoscope (referred to hereinafter as an ‘endoscope’) is a medical device that is inserted into an internal organ or body cavity to enable an operator to see the inside without having to perform an invasive operation. Ever since its conception in 1863 by Kussmaul, it has made an immense contribution to developments in the medical field.

Looking at the history of the endoscope's development, at the beginning there was the first-generation endoscope, with which the shapes drawn on a bundle of optical fibers were combined to provide a crude image, whereas the mainstream version now is the second-generation endoscope, which uses the lenses of a miniature camera to photograph a required portion and shows the image clearly on a monitor screen.

Typically, the endoscope is divided into the flexible type endoscope, in which the probe having an objective lens equipped on its front end can be freely bent, and the rigid type endoscope, in which the probe forms a straight line without being bent.

A lens module that uses an image sensor such as a CCD or a CMOS for forming an image is installed at the forward end of an endoscope, where a plurality of different lenses are arranged to form the lens module in order that the performance of the endoscope may be improved, such as in terms of viewing angle or resolution.

Japanese Patent Publication No. 2000-028929 discloses an “Endoscopic objective optical system” that can easily align the center of the aperture with the optical axis without causing flares or ghosts.

Also, Japanese Registered Patent No. 4668665 discloses an “Objective lens portion of endoscope” that can be secured onto the objective lens cylinder in an accurate and reliable manner and in a short processing time by having a shading mask exactly fit the cross-sectional shape of the optical path of the projection of the observed image. Also, International Patent Publication No. WO2016/190184 discloses an “Endoscope objective optical system” that has a wide viewing angle, low variations in the viewing angle, and a short overall length of the optical system. FIG. 1 illustrates an example of the endoscope objective optical system disclosed in International Patent Publication No. WO2016/190184.

As disclosed in the patent publications above, the objective optical system (or objective optics part or lens module; hereinafter referred to as the “lens module”) formed on the forward end of the endoscope includes a plurality of lenses having different curvatures or diameters that may be arranged in various forms on an optical axis to form an image as an image sensor.

Here, some of the plurality of lenses forming a typical lens module may be positioned in contact with one another, as in the example illustrated in FIG. 1, but most of the lenses remain separated from one another by a certain distance. From an optics perspective, this separated distance between lenses must be maintained with precision if the desired image is to be obtained, and a defect resulting from an inability to maintain the desired distance can be a direct cause of lowered image quality.

Here, a conventional method of controlling the distance between lenses in a lens module includes placing a spacer between the lenses to maintain the distance, as illustrated in FIG. 1, or forming a spacer and a curb that protrudes towards the center from the inner surface of the case to maintain the distance as in Japanese Registered Patent No. 4668665.

However, the method of installing a spacer according to the related art entails the problem that an additional process of inserting the spacer between two lenses is needed, as well as the problem that inserting the relatively small spacer into the case is not an easy task.

Also, when forming a curb on the inner wall of the case according to the related art, the lenses must be inserted from both sides of the case with the curb in-between. Thus, a more complex process is needed, which involves inserting a lens from one side, securing the lens, and then inserting a lens from the other side.

Also, in the case of a conventional lens module, the problem of having to use a plurality of lenses having different diameters was resolved by processing the inner diameter of the case to match the diameters of the lenses or by superimposing two or more cases that have different inner diameters, but these methods require a complicated manufacturing process and increase manufacturing costs.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a lens module for an endoscope and an endoscope using the lens module where the distance between the lenses can be controlled by the lens structure of the lens itself without having to use a separate spacer.

Another objective of the present invention is to provide a lens module for an endoscope and an endoscope using the lens module that can be installed within a case of a single diameter while being capable of performing the same functions as existing devices that use lenses of different diameters.

In order to achieve the objectives above, according to one aspect of the present invention, there is provided a lens module for an endoscope. The lens module includes: a case that is shaped as a tube and has a holding space formed therein, and a plurality of lenses arranged inside the case, wherein the plurality of lenses include a first lens and a second lens that are positioned adjacently and are separated by a particular distance in-between, the first lens comprising a first forward-direction protrusion protruding towards the second lens from an edge region of a radial direction, the first forward-direction protrusion formed as an integrated body with the first lens to control the distance between the first lens and the second lens.

Here, the second lens can include a first reverse-direction protrusion that protrudes towards the first lens from an edge region of a radial direction, where the first reverse-direction protrusion contacts the first forward-direction protrusion to control the distance between the first lens and the second lens together with the first forward-direction protrusion.

Also, the plurality of lenses can include a third lens that is positioned at the opposite side of the second lens with the first lens located in-between and is separated from the first lens by a particular distance; and the first lens can further include a second reverse-direction protrusion that protrudes towards the third lens from an edge region of a radial direction to control the distance between the first lens and the third lens.

The first lens can include: an effective region configured to perform an optical function of the lens module for an endoscope; and a flange region extending outward in a radial direction from the effective region such that a far end contacts an inner wall of the case, wherein the first forward-direction protrusion can be formed in the flange region.

The case can be formed with a constant inner diameter, and the plurality of lenses can be prepared with a diameter corresponding to the inner diameter of the case and can be sequentially inserted to and arranged on the inside of the case. At least one of the plurality of lenses can include an effective region and a flange region, the effective region configured to perform an optical function of the lens module for an endoscope, and the flange region extending outward in a radial direction from the effective region such that a far end contacts an inner wall of the case, so that at least one of the plurality of lenses can have the flange region extending in correspondence to the inner diameter of the case.

A blackening treatment can be applied to a surface of the flange region.

The effective region, the flange region, and the first forward-direction protrusion can be fabricated as an integrated body from a glass material.

Another embodiment of the present invention provides an endoscope in which the lens module for an endoscope described above may be mounted. The objectives above can also be achieved by said endoscope.

According to an embodiment of the present invention having the composition described above, a lens module for an endoscope and an endoscope using the lens module are provided in which a protrusion is formed in a forward direction or in an reverse direction from an edge region of the lens, with the protrusion fabricated from a glass material as an integrated body with the lens, so that the lens module can be fabricated simply by sequentially inserting the lenses without having to insert a separate spacer or form a step or curb in the inner wall of the case.

Also, in regard to using lenses that have different diameters due to differences in the radii of curvature, etc., an embodiment of the present invention can entail forming a flange region that extends outwards in a radial direction from the edge of the effective region, which performs the main function of the lens, thereby conforming the diameters of all of the lenses and enabling the manufacture of the lens module by a method of sequentially inserting the lenses into a case having a constant inner diameter.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram showing an example of an endoscope objective optical system disclosed in International Patent Publication No. WO2016/190184;

FIG. 2 is a simplified view showing only the lenses in the endoscope objective optical system of FIG. 1;

FIG. 3 is a diagram illustrating an example of a lens module for an endoscope according to an embodiment of the present invention; and

FIGS. 4A to 4G are diagrams each of which illustrates a lens forming the lens module for an endoscope shown in FIG. 3.

### DETAILED DESCRIPTION OF THE INVENTION

Hereinbelow, exemplary embodiments of the present invention will be described in detail with reference to the accompanying drawings. Throughout the drawings, the same reference numerals will refer to the same or like parts.

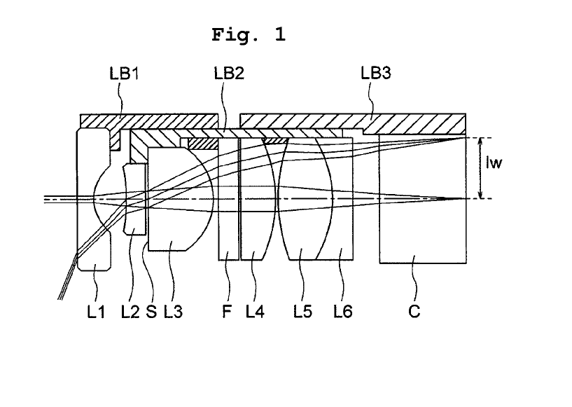

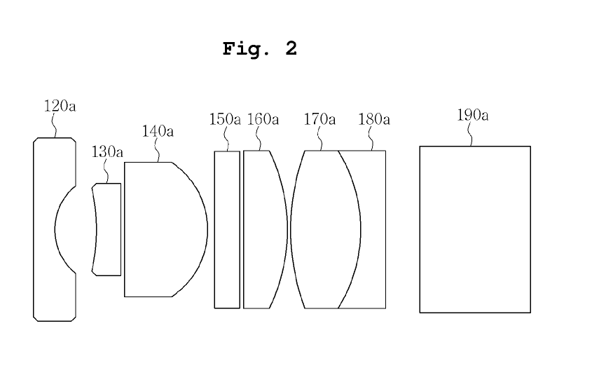

FIG. 2 is a simplified view showing only the lenses 120a-190a in the endoscope objective optical system disclosed in International Patent Publication No. WO2016/190184 shown in FIG. 1. As illustrated in FIG. 2, the plurality of lenses 120a-190a forming a lens module generally have different diameters and are positioned in contact or separated by a particular distance depending on the optical properties.

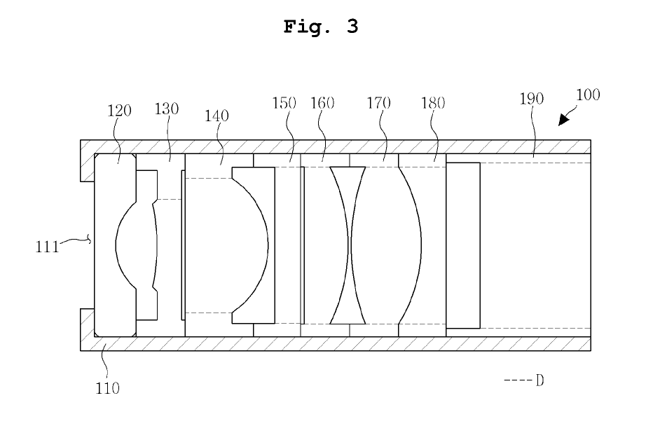

FIG. 3 is a diagram illustrating an example of a lens module 100 for an endoscope according to an embodiment of the present invention, where the illustrated example is designed to exhibit the same optical properties as the endoscope objective optical system illustrated in FIG. 2. Referring to FIG. 3, a lens module 100 for an endoscope according to an embodiment of the present invention includes a case 110 and a plurality of lenses 120-190 arranged inside the case 110.

The case 110 has the general shape of a tube in which a holding space is formed for holding the plurality of lenses 120-190 therein. At the front end and rear end of the case 110, a front opening 111 and a rear opening (not shown) may be formed, respectively, lying on the optical path.

The plurality of lenses 120-190 are positioned in the holding space of the case 110 and are positioned in contact with one another or separated by a particular distance in order to improve the optical properties. That is, the plurality of lenses 120-190 include a pair of lenses 160,170 that are positioned adjacent to each other with a particular distance separating the pair, and from among the lenses 120-190 illustrated in FIG. 2, the descriptions herein will use lens 160 and lens 170 as examples, with lens 160 referred to arbitrarily as a ‘first lens 160’ and lens 170 referred to arbitrarily as a ‘second lens 170’.

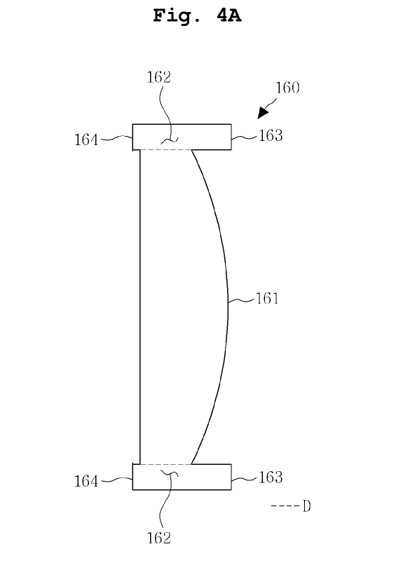

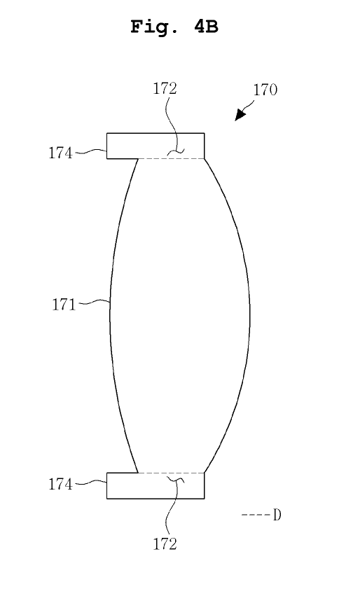

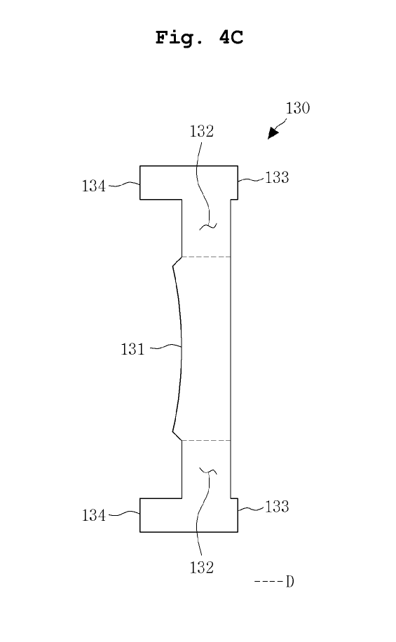

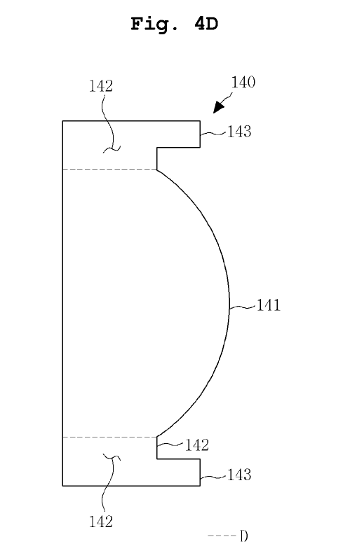

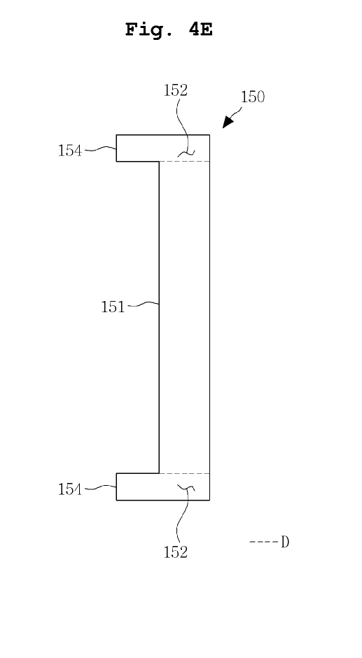

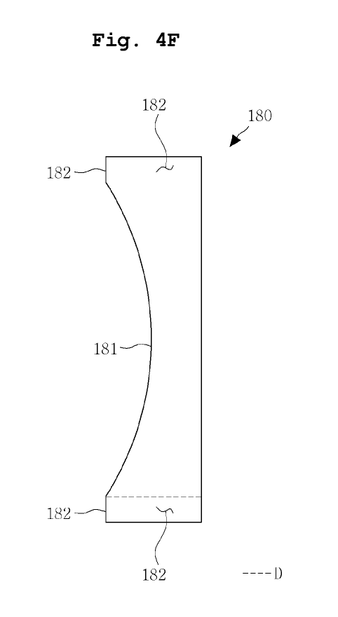

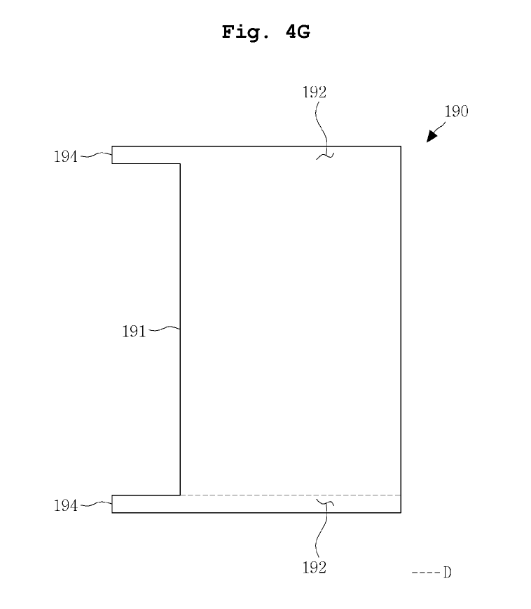

FIG. 4A illustrates the first lens 160, while FIG. 4B illustrates the second lens 170. First, with reference to FIG. 3 and FIG. 4A, a first lens 160 according to an embodiment of the present invention includes a protrusion 163 (hereinafter referred to as a ‘first forward-direction protrusion’) that protrudes towards the second lens 170 from an edge region of the radial direction. Here, the first forward-direction protrusion 163 protrudes from the first lens 160 towards the second lens 170 to control the distance between the first lens 160 and the second lens 170 while contacting the second lens 170.

Here, the first forward-direction protrusion 163 is formed as an integrated body with the first lens 160, and in cases where the first lens 160 according to an embodiment of the present invention is fabricated from a glass material, the cast for forming the first lens 160 may include a portion for the first forward-direction protrusion 163, so that the first forward-direction protrusion 163 is formed as an integrated body with the first lens 160.

The composition set forth above allows easier manufacture of the lens module 100, as the protrusion 163 can be formed on an edge region of the first lens 160 during the manufacturing process of the first lens 160 without having to install a separate spacer, and the distance between the first lens 160 and the second lens 170 can be controlled simply by inserting the first lens 160.

Again, referring to FIG. 3 and FIG. 4B, the second lens 170 can include a protrusion 174 (hereinafter referred to as a “first reverse-direction protrusion”) that protrudes towards the first lens 160 from an edge region of the radial direction. Here, the first reverse-direction protrusion 174 contacts the first forward-direction protrusion 163 of the first lens 160, so that the distance between the first lens 160 and the second lens 170 can be controlled by controlling the lengths of the first forward-direction protrusion 163 and the first reverse-direction protrusion 174 along the direction of the optical path.

Thus, in cases where the distance between the first lens 160 and the second lens 170 is to be relatively long, the distance can be controlled by forming a first forward-direction protrusion 163 on the first lens 160 and forming a first reverse-direction protrusion 174 on the second lens 170. Since there is no overly long protrusion formed on any one side, the first lens 160 and second lens 170 can be manufactured more easily, and damage to the protrusions 163,174 can be prevented during the manufacturing process of the first lens 160 and second lens 170 or during the assembly process of the lens module 100.

In cases where a lens 150 is to be located on the opposite side of the second lens 170 with the first lens 160 in-between, i.e. in cases where the lens 150 (hereinafter referred to as a “third lens 150”) is to be positioned separated by a particular distance from the first lens 160, the first lens 160 can include a protrusion 164 (hereinafter referred to as a “second reverse-direction protrusion”) that protrudes from an edge region of a radial direction towards the third lens 150. Here, the second reverse-direction protrusion 164 contacts the third lens 150 and can be used to control the distance between the first lens 160 and the third lens 150.

In other words, in the edge region of the first lens 160, a first forward-direction protrusion 163 and a second reverse-direction protrusion 164 are formed on both sides, respectively, along the direction of the optical path, to maintain the distances from the second lens 170 and the third lens 150.

Thus, using one first lens 160, it is possible to maintain the distances from the second lens 170 and third lens 150, which are positioned on either side, respectively, along the direction of the optical path, due to the first forward-direction protrusion 163 and the second reverse-direction protrusion 164 that are formed as an integrated body during the manufacturing process of the first lens 160, and the distances between the lenses 150,160,170 can be controlled with a process of sequentially inserting the third lens 150, first lens 160, and second lens 170 into the case 110 when manufacturing the lens module 100.

A first lens 160 according to an embodiment of the present invention can include an effective region 161 and a flange region 162, as illustrated in FIG. 4A. Here, the effective region 161 refers to the region that performs the optical function of the lens module 100 for an endoscope, and in the present specification, is arbitrarily represented as meaning the region up to the diameter of a conventional lens 120a-190a illustrated in FIG. 2. For instance, the dotted lines D in FIG. 3 and FIGS. 4A to 4G represent the diameter locations of the conventional lenses 120a-190a illustrated in FIG. 2, and in an embodiment of the present invention, the region reaching from the optical axis to the dotted lines is defined as an effective region (for instance, 161), and the region extending outwardly in a radial direction from the effective region 161 such that the far end contacts the inner wall surface of the case 110 is defined as a flange region (for instance, 162).

As illustrated in FIG. 4A, the first forward-direction protrusion 163 and the second reverse-direction protrusion 164 of the first lens 160 can be formed in the flange region 162.

According to the composition set forth above, when the design of the optically effective regions, for instance a design such as that illustrated in FIG. 2, is completed for the design of the lens module 100 for an endoscope, it is possible to manufacture the lens module 100 using a method that includes forming the case 110 with a constant inner diameter, as illustrated in FIG. 3, and forming the flange region (for instance, 162) together during the manufacture of the corresponding lens (for instance, 160) where the diameter of the effective region (for instance, 161) is smaller than the inner diameter of the case 110, simply by sequentially inserting the lenses 120-190 into a case 110 having a constant inner diameter after preparing the lenses 120-190 to correspond to the inner diameter of the case 110, as illustrated in FIG. 3. Here, the effective region 161, flange region 162, first forward-direction protrusion 163, and second reverse-direction protrusion 164 of the first lens 160, for example, can be fabricated as an integrated body by a manufacturing process that utilizes a cast as already described above.

Although the embodiments set forth above describe the compositions of the lenses 120-190 according to an aspect of the present invention by using the composition of the first lens 160 as an example, it is to be appreciated that the terms ‘first’, ‘second’, and ‘third’ are designated arbitrarily and that every one of the lenses 120-190 illustrated in FIG. 3 can be regarded as a ‘first’, ‘second’, or ‘third’ lens 120-190.

Also, in the descriptions of the protrusions 163,164,174 of the first lens 160 and second lens 170, it is to be appreciated that the terms ‘forward direction’ and ‘reverse direction’ are designated arbitrarily to describe the protrusions protruding in two directions from a single lens 120-190 and that it is not absolutely necessary for the directions of the protrusions to match the directions illustrated in FIG. 3.

To be more specific, can be seen that the lens 170 illustrated in FIG. 4B, i.e. the second lens 170 described above, is composed of an effective region 171, a flange region 172, and a first reverse-direction protrusion 174. Here, the term ‘first reverse-direction protrusion’ of the second lens 170 is designated for the sake of convenience, and it can be said simply that the second lens 170 includes a protrusion 174 for controlling the distance to an adjacent lens 160, i.e. the first lens 160 of FIG. 3.

Similarly, the lens 130 illustrated in FIG. 4C shows an example that includes an effective region 131 and a flange region 132, as well as a protrusion 134 for controlling the distance to lens 120 and a protrusion 133 for controlling the distance to lens 140.

Also, the lens 140 illustrated in FIG. 4D shows an example that includes an effective region 141, a flange region 142, and a protrusion 143 for controlling the distance to lens 150. The lens 150 illustrated in FIG. 4E shows an example that includes an effective region 151, a flange region 152, and a protrusion 154 for controlling the distance to lens 140. Here, lenses 140 and 150 show an example of the distance being controlled by protrusions 143, 154 that protrude toward each other.

The lens 180 illustrated in FIG. 4F shows an example that includes an effective region 181 and a flange region 182, where the effective region 181 is in contact with the effective region 161 of the second lens 170, and the distance from lens 190 is controlled by the protrusion 194 of lens 190. Here, the lens 190 illustrated in FIG. 4G shows an example that includes a protrusion 194 for controlling the distance to lens 180, an effective region 191, and a flange region 192.

In describing the embodiments above, the differentiating between the effective region 161-191 and the flange region 162-192 of a lens 120-190 is described using an example in which the differentiation is based on the diameters of the conventional lenses 120a-190a illustrated in FIG. 2. In addition, it is apparent that, in the structural designs of the lenses, the regions performing optical functions can be designated the effective regions and the regions extending outward for insertion into the case 110 having a constant inner diameter can be designated the flange regions. Here, it is to be appreciated that, as regards the composition of a lens 120-190 according to an embodiment of the present invention, a blackening treatment can be applied to the surface of the flange region 162-192 or the protrusions (153, etc.) so as to minimize their optical impact. Although certain preferred embodiments of the present invention have been described for illustrative purposes, those skilled in the art will appreciate that various modifications, additions and substitutions are possible, without departing from the scope and spirit of the invention as defined by the accompanying claims and their equivalents.

### DESCRIPTION OF REFERENCE NUMERALS

100: lens module for an endoscope
110: case
111: front opening
120,130,140,150,160,170,180,190: lens
131,141,151,161,171,181,191: effective region
132,142,152,162,172,182,192: flange region
133,134,143,154,163,164,174,194: protrusion

1. A lens module for an endoscope, the lens module comprising:
a case shaped as a tube having a holding space formed therein, and
a plurality of lenses arranged inside the case;
wherein the plurality of lenses include a first lens and a second lens, the first lens and the second lens positioned adjacently and separated by a particular distance in-between;
and the first lens comprises a first forward-direction protrusion protruding towards the second lens from an edge region of a radial direction, the first forward-direction protrusion formed as an integrated body with the first lens to control a distance between the first lens and the second lens.

2. The lens module for an endoscope according to claim 1, wherein the second lens comprises a first reverse-direction protrusion protruding towards the first lens from an edge region of a radial direction, the first reverse-direction protrusion configured to contact the first forward-direction protrusion to control a distance between the first lens and the second lens together with the first forward-direction protrusion.

3. The lens module for an endoscope according to claim 1, wherein the plurality of lenses include a third lens, the third lens positioned at an opposite side of the second lens with the first lens located in-between, the third lens separated by a particular distance from the first lens;
and the first lens further comprises a second reverse-direction protrusion protruding towards the third lens from an edge region of a radial direction to control a distance between the first lens and the third lens.

4. The lens module for an endoscope according to claim 1, wherein the first lens comprises:
an effective region configured to perform an optical function of the lens module for an endoscope, and
a flange region extending outward in a radial direction from the effective region such that a far end contacts an inner wall of the case;
and the first forward-direction protrusion is formed in the flange region.

5. The lens module for an endoscope according to claim 1, wherein the case is formed with a constant inner diameter, the plurality of lenses are prepared with a diameter corresponding to the inner diameter of the case and sequentially inserted to and arranged on an inside of the case;
and at least one of the plurality of lenses comprises an effective region and a flange region, the effective region configured to perform an optical function of the lens module for an endoscope, the flange region extending outward in a radial direction from the effective region such that a far end contacts an inner wall of the case, the at least one of the plurality of lenses having the flange region extending in correspondence to the inner diameter of the case.

6. The lens module for an endoscope according to either claim 4, wherein a blackening treatment is applied to a surface of the flange region.

7. The lens module for an endoscope according to either claim 4, wherein the effective region, the flange region, and the first forward-direction protrusion are fabricated as an integrated body from a glass material.

8. An endoscope having mounted therein the lens module according to claim 1.
